(19) United States
(12) Patent Application Publication
(10) Pub. No.: US 2013/0233122 A1
(43) Pub. Date: Sep. 12, 2013

(54) STRAP HAND CRANK

(71) Applicant: Michael Smith, Houston, TX (US)

(72) Inventor: Michael Smith, Houston, TX (US)

(21) Appl. No.: 13/413,476

(22) Filed: Mar. 6, 2012

(51) Int. Cl. B66D 1/04

(52) U.S. Cl. 74/557

(57) ABSTRACT

The present invention is a strap hand crank that includes a bent steel rod that has a proximal portion and a distal portion and is bent to allow a user to fasten the strap hand crank to a winch to be easily turned or rotated, a metal cylinder with a swivel action capability that has a distal end and forms the proximal portion of the bent steel rod, a rubber cover that provides additional comfort, grasping capability and avoids static electricity that covers a handle that forms the distal portion of the bent steel rod and that moves forward or rewinds and makes the strap hand crank easier to turn and an end cap that is disposed on the distal end of the metal cylinder to cover and protect the distal end of the metal cylinder.

### TECHNICAL FIELD & BACKGROUND

Many truckers utilize straps to secure loads of boxes when travelling. It can be time consuming and difficult to wind and unwind a large amount of straps when attempting to quickly and efficiently unload cargo.

The present invention generally relates to a hand crank. More specifically, the invention is a strap hand crank.

It is an object of the invention to provide a strap hand crank that utilizes a plurality of pry bar slots on a winch to turn a winch.

It is an object of the invention to provide a strap hand crank that is utilized with one hand while a user can utilize another hand to guide a strap straight on a winch.

It is an object of the invention to provide a strap hand crank that allows a user to spend less time and energy rewinding straps on one or more winches.

What is really needed is a strap hand crank that utilizes a plurality of pry bar slots on a winch to turn a winch that is utilized with one hand while a user can utilize another hand to guide a strap straight on a winch and that allows a user to spend less time and energy rewinding straps on one or more winches.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a strap hand crank, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

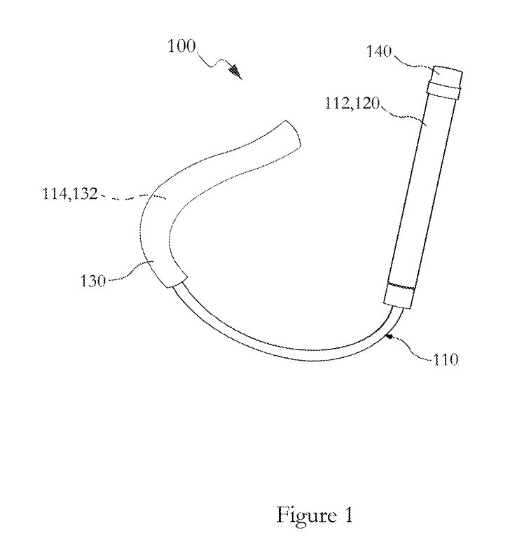

FIG. 1 illustrates a side view of a strap hand crank 100, according to an embodiment of the present invention. The strap hand crank 100 is typically utilized by truckers and dock workers to secure to one or more loads of boxes or other suitable cargo when traveling but can be used in other suitable situations as well. The strap hand crank 100 is specifically shaped to go through and around the pry bar of a winch. The strap hand crank 100 is designed to be used with a plurality of ratchets sizes to allow swift and easy usage.

The strap hand crank 100 includes a bent steel rod 110, a metal cylinder 120, a rubber cover 130 and an end cap 140.

The bent steel rod 110 is bent to allow a user to fasten the strap hand crank 100 to a winch to be relatively easily turned or rotated. The bent steel rod 110 that has a proximal portion 112 and a distal portion 114 is approximately 15″ in total length but can be any suitable length. The metal cylinder 120 has a distal end 122 and forms the proximal portion 112 of the bent steel rod 110 that has a swivel action capability. The metal cylinder 120 is approximately 5″ in length but can be any suitable length. The rubber cover 130 covers a handle 132 that forms the distal portion 114 of the bent steel rod 110 and provides additional comfort, grasping capability and avoids static electricity. The rubber cover 130 is approximately 3″ in length but can be any suitable length. The rubber cover 130 and handle 132 can move the strap hand crank 100 that can be moved forward or rewind and makes the strap hand crank 100 relatively easier to turn and rotate a winch, making it relatively easier and faster to handle cargo and other suitable items. The end cap 140 is disposed on the distal end 122 of the metal cylinder 120 to cover and protect the distal end 122 of the metal cylinder 120.

The strap hand crank is a portable attachment for a strap. Simply fasten the approximately 15″ long steel rod, which is bent to create an approximate 5″ long handle through one or more universal pry bar slots on a winch. To prevent static electricity, an approximate 5″ rubber pad is placed on a curved end of the strap hand crank to serve as a cushion. The strap hand crank can be made to move forward or rewind, a swivel handle that makes the strap hand crank relatively easier to turn. Transportation industry workers are among the many people who may find the strap hand crank both convenient and easy to use. The strap hand crank features an approximate 15″ steel rod, shaped to go through and around the pry bar of a winch. The strap hand crank is designed to be used with several sizes of ratchets for relatively swift and effortless operation.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A strap hand crank, comprises:
a bent steel rod that has a proximal portion and a distal portion and is bent to allow a user to fasten said strap hand crank to a winch to be easily turned or rotated;
a metal cylinder that has a distal end and forms said proximal portion of said bent steel rod;
a rubber cover that covers a handle that forms said distal portion of said bent steel rod; and
an end cap that is disposed on said distal end of said metal cylinder to cover and protect said distal end of said metal cylinder.

2. The strap hand crank according to claim 1, wherein said metal cylinder has a swivel action capability.

3. The strap hand crank according to claim 1, wherein said handle provides additional comfort, grasping capability and avoids static electricity.

4. The strap hand crank according to claim 1, wherein said rubber cover and handle moves said strap hand crank that moves forward or rewinds and makes said strap hand crank easier to turn.

5. The strap hand crank according to claim 1, wherein said rubber cover and handle rotate said winch making it easier and faster to handle cargo and one or more other items.

6. The strap hand crank according to claim 5, wherein said strap hand crank is utilized by one or more truckers and one or more dock workers to secure one or more loads of boxes or said cargo.

7. The strap hand crank according to claim 1, wherein said strap hand crank is specifically shaped to go through and around a pry bar of said winch.

8. A strap hand crank, comprises:
a bent steel rod that has a proximal portion and a distal portion and is bent to allow a user to fasten said strap hand crank to a winch to be easily turned or rotated;
a metal cylinder with a swivel action capability that has a distal end and forms said proximal portion of said bent steel rod;
a rubber cover that provides additional comfort, grasping capability and avoids static electricity that covers a handle that forms said distal portion of said bent steel rod and that moves forward or rewinds and makes said strap hand crank easier to turn; and
an end cap that is disposed on said distal end of said metal cylinder to cover and protect said distal end of said metal cylinder.

9. The strap hand crank according to claim 8, wherein said bent steel rod is approximately 15″ in total length.

10. The strap hand crank according to claim 8, wherein said rubber cover and handle rotate said winch making it easier and faster to handle cargo or one or more other items.

11. The strap hand crank according to claim 10, wherein said strap hand crank is utilized by one or more truckers and one or more dock workers to secure to one or more loads of boxes or said cargo.

12. The strap hand crank according to claim 8, wherein said strap hand crank is specifically shaped to go through and around a pry bar of said winch.

13. The strap hand crank according to claim 8, wherein said strap hand crank is used with a plurality of ratchets sizes to allow swift and easy usage.

14. A strap hand crank, comprises:
a bent steel rod that has a proximal portion and a distal portion and is bent to allow a user to fasten said strap hand crank to a winch to be easily turned or rotated;
a metal cylinder with a swivel action capability that has a distal end and forms said proximal portion of said bent steel rod;
a rubber cover that provides additional comfort, grasping capability and avoids static electricity that covers a handle that forms said distal portion of said bent steel rod that moves forward or rewinds and makes said strap hand crank easier to turn and rotate said winch making it easier and faster to handle cargo or one or more other items; and
an end cap that is disposed on said distal end of said metal cylinder to cover and protect said distal end of said metal cylinder.

15. The strap hand crank according to claim 14, wherein said bent steel rod is approximately 15″ in total length.

16. The strap hand crank according to claim 14, wherein said metal cylinder is approximately 5″ in length.

17. The strap hand crank according to claim 14, wherein said rubber cover is approximately 3″ in length.

18. The strap hand crank according to claim 14, wherein said strap hand crank is utilized by one or more truckers and one or more dock workers to secure one or more loads of boxes or said cargo.

19. The strap hand crank according to claim 14, wherein said strap hand crank is specifically shaped to go through and around a pry bar of said winch.

20. The strap hand crank according to claim 14, wherein said strap hand crank is used with a plurality of ratchets sizes to allow swift and easy usage.
